(19) United States
(12) Patent Application Publication
(10) Pub. No.: US 2014/0106643 A1
(43) Pub. Date: Apr. 17, 2014

(54) GAME CALL

(71) Applicant: Richard Powers, Mill Hall, PA (US)

(72) Inventor: Richard Powers, Mill Hall, PA (US)

(21) Appl. No.: 14/047,140

(22) Filed: Oct. 7, 2013

Related U.S. Application Data
(60) Provisional application No. 61/712,912, filed on Oct. 12, 2012.

(51) Int. Cl. A01M 31/00

(52) U.S. Cl. CPC A01M 31/004
USPC 446/418

(57) ABSTRACT

A game call having a striking plate and a striker. The striking plate includes a striking surface and a housing having a base and a sidewall. In certain embodiments, the striker is striker is tethered to the striking plate by retractable tether that allows the striker to freely rub the striking plate when in use but holds the striker close to the striking plate when the call is not in use. In other embodiments, striker is inserted into the striking plate and retained there when the call is not in use.

### CROSS-REFERENCE TO RELATED APPLICATIONS

This application claims priority under 35 U.S.C. §119(e)(1) from U.S. Provisional Patent Application No. 61/712,912, filed on Oct. 12, 2012, for “Turkey Call,” the disclosure of which is incorporated herein by reference.

### STATEMENT REGARDING FEDERALLY SPONSORED RESEARCH

Not Applicable.

### BACKGROUND

1. Field of Invention

The present invention relates to game calls. In particular, the present invention relates to game calls capable of producing artificial sounds that attract game such as turkeys.

2. Description of Related Art

Game calls are often used in the act of hunting. For example, turkey calls function by attempting to mimic the natural sounds of a female turkey, the hen, in an effort to attract the male turkey, the gobbler, to travel within range of the hunter operating the call. One commonly-used turkey call is known as a friction call. A friction call consists of a striker and a striking plate. The hunter rubs the head of the striker against the striking plate. The friction created at the point where the striker contacts the striking plate creates the sound that is intended to mimic natural turkey sounds. The striker and striking plate can each be made of different materials so that the friction call can be “tuned” to mimic the desired turkey sound.

One problem inherent with known friction calls is the propensity of hunters to lose the components of the call, particularly the striker. Hunting requires the hunter to hike to remote locations and spend significant time waiting for game (e.g., turkeys) to travel within range. As a result, hunters typically pack and carry a large amount of supplies to travel to, and wait out, the game being hunted. Strikers are known to fall out of pockets as the hunter hikes to his/her hunting location and be left on the ground after the hunter has unpacked/packed his or her supplies while hunting. Accordingly, there is a need for a friction call that minimizes the risk of losing the components of the friction call, especially the striker.

Attempts have been made to solve this problem. For example, U.S. Pat. No. 6,010,389 to Terll discloses a gun having a wild game call integrally mounted therein. U.S. Pat. No. 5,607,091 to Musacchia discloses a game call holder comprising a tethered striker. U.S. Pat. No. 4,941,858 to Adams discloses a turkey call comprising a means of mounting the striker through the resonance chamber. Notwithstanding these attempts, there is still a particular need for a game call that minimizes the risk of losing the striker yet is easy to transport over distance.

### SUMMARY

In general, the invention relates to devices capable of producing artificial game calls that useful for activities such as hunting and game watching. The present invention is a friction call that minimizes the risk of losing the striker and/or striking plate. In one embodiment, the invention comprises a striker that is tethered to the striking plate by retractable tether that allows the striker to freely rub the striking plate when in use but holds the striker close to the striking plate when the call is not in use. In another embodiment, the invention comprises a striker that can be inserted into the striking plate and retained there when the call is not in use. Keeping the striker close to the striking plate prevents the striker from becoming entangled with brush as the user hikes to his or her hunting/watching location.

### BRIEF DESCRIPTION OF THE DRAWINGS

FIG. 1 is a perspective drawing of one embodiment of the present invention.

FIG. 2 is a perspective drawing of one embodiment of the present invention.

### DETAILED DESCRIPTION

It is contemplated that articles, apparatus, methods, and processes of the claimed invention encompass variations and adaptations developed using information from the embodiments described herein. Adaptation and/or modification of the articles, apparatus, methods, and processes described herein may be performed by those of ordinary skill in the relevant art. Throughout the description, where articles and apparatus are described as having, including, or comprising specific components, or where processes and methods are described as having, including, or comprising specific steps, it is contemplated that, additionally, there are articles and apparatus of the present invention that consist essentially of, or consist of, the recited components, and that there are processes and methods according to the present invention that consist essentially of, or consist of, the recited processing steps.

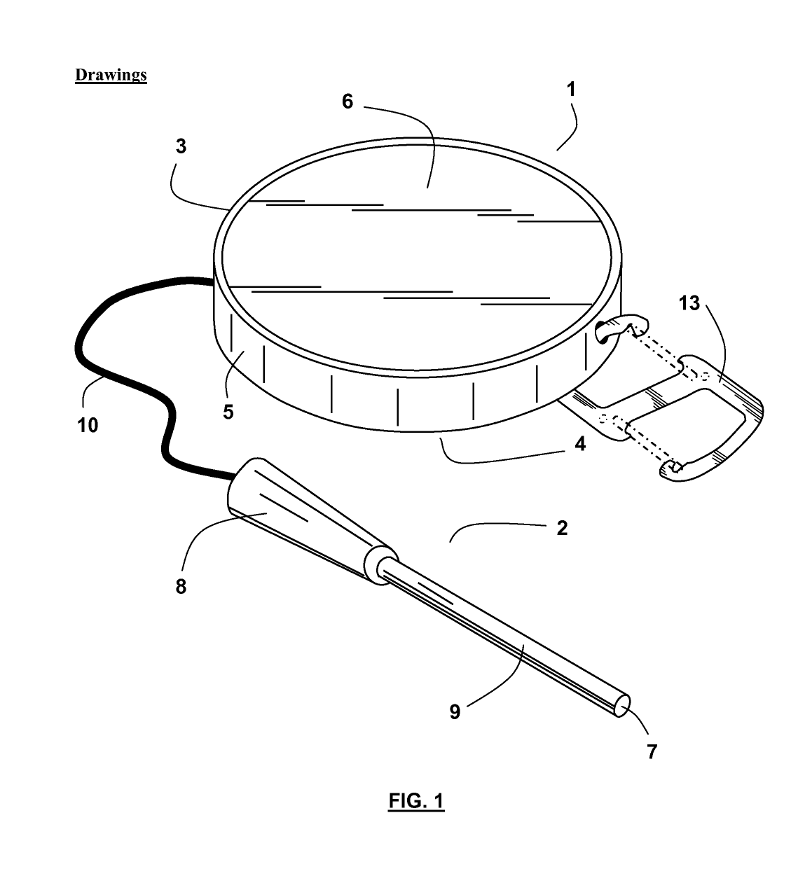

In FIG. 1, an embodiment of a game call consistent with the present invention is shown. The game call comprises a striking plate 1 and a striker 2. The striking plate 1 is comprised of a striking surface 6 and a housing 3 having a base 4 and a sidewall 5. The housing 3 may be formed of plastic, carbon or wood, or any other suitable material, as is known by those skilled in the art. It will be appreciated that the shape of the housing 3, as shown in FIG. 1, is for illustrative purposes only and that other shapes may be utilized to make the housing 3.

The striking plate 1 further comprises a striking surface 6 that is configured to attach or sit on the opening of the housing 3. The striking surface 6 may be made of a material selected from the group consisting of aluminum, stainless steel, and other suitable metals or composite materials. As is known, the material or materials selected to form the striking surface 6 will produce a particular pitch and timbre, as the manufacturer or user may desire. Artificial game sounds (e.g., turkey sounds) are produced when the striking surface 6 is contacted by the striking end 7 of the striker 2, that is moved relative to the striking surface 6, as is generally known.

The striker 2 includes a handle end 8 and a striking rod 9 having a striking end 7 that actually contacts the striking surface 6 to produce the desired turkey sounds. The handle end 8 may be made of wood, metal, plastic or any other suitable material. The striking rod 9 and striking end 7 are preferably made of wood, but may be made of other suitable materials such as glass and carbon. As shown in the embodiment of FIG. 1, a clip 13 (e.g., a karabiner as shown) may be attached to the striking plate 1 and used as means to attach the call to the hunter's/hiker's clothing or pack.

In the embodiment shown in FIG. 1, the handle end 8 is attached to a tether 10. The other end of the tether 10 is connected to a retracting means contained within the housing 3. In the embodiment shown in FIG. 1, the tether 10 comprises a woven rope and the retracting means comprises a spring-driven reel (e.g., a standard badge reel, not shown) positioned and affixed inside the housing 3, although any known means of retracting the tether 10 can be used. The retracting means automatically retracts the tether 10 when any tension on the tether 10 is released, thereby retracting the striker 2 until the handle end 8 meets the sidewall 5. In this way, the striker 2 is held close to the striking plate 1 when the call is not in use, but a user may quickly pull the striker 2 away from the striking plate 1 when needed to operate the call, only to later retract the striker 2 once it is no longer needed.

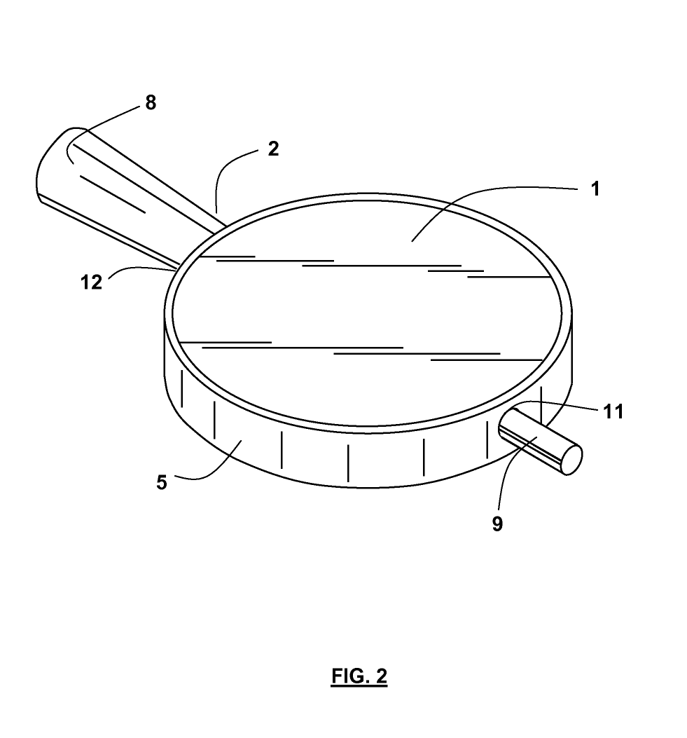

In the alternative embodiment shown in FIG. 2, two opposing holes (11, 12) are bored through the sidewall 5. The striking rod 9 may then be threaded through the holes (11, 12) as shown in FIG. 2 whenever the call is not being used. When the user wants to use the call, he or she removes the striker 2 from the striking plate 1 by pulling the handle end 8 away from the striking plate 1. When finished, the striker 2 is returned to the striking plate 1.

What is claimed is:

1. A game call comprising:
(a) a striker;
(b) a striking plate;
(c) a tether having a first tether end connected to said striker; and
(d) a retracting means positioned inside of said striking plate and connected to said tether so as to apply a retracting force to said tether.

2. The game call of claim 1, wherein said retracting means comprises a spring-driven reel.

3. The game call of claim 1, wherein said tether comprises a woven rope.

4. A game call comprising:
(a) a striker comprising a handle end and a striking rod; and
(b) a striking plate comprising a striking surface, a base, and a sidewall, wherein said sidewall two opposing holes along its length capable of receiving said striking rod.
